(19) United States
(12) Patent Application Publication
(10) Pub. No.: US 2005/0119101 A1
(43) Pub. Date: Jun. 2, 2005

(54) Method and apparatus for manufacturing handles for bags

(75) Inventor: Malcolm Constant, East Peckham (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Dempson Packaging, Ltd., Maidstone (GB)

(21) Appl. No.: 10/916,731

(22) Filed: Aug. 12, 2004

(30) Foreign Application Priority Data
Aug. 14, 2003 (GB) 0319102.0

(51) Int. Cl. B31B 1/86

(52) U.S. Cl. 493/221

(57) ABSTRACT

The present invention is concerned with a machine which manufactures substantially U-shaped handles for attachment to bags or bag making stock so as to provide a bag with substantially U-shaped handles attached. The substantially U-shaped handles are manufactured from paper strip which is divided longitudinally into further paper strips which are fed to separate former drums. Here, substantially U-shaped handles are formed and attached to bags, thereby producing handled bags. The substantially U-shaped handles are concurrently attached to either side of the preformed bags or bag making stock. The former drum makes use of a mechanical gripper means and a raised rail guide so as to hold the substantially U-shaped handles to the former drum and maintain the folded position of the legs of the handle once folded over. The preformed bags are supplied by a removable bag supply unit or alternatively a continuous feed of preformed bags or bag making stock. A combination of a mechanical gripper and air under pressure is used to remove the bags from the bag supply unit. The bag making machine of the present invention may be accessed by opening an entire side of the machine.

The present invention relates to a machine for forming and applying paper bag handles to bags.

Many forms of bags are used for packaging purposes or to carry shopping. These bags are easier to carry when provided with a pair of handles. Bags can be made of paper, foil material, plastic, fabric or the like, but it is particularly, though not necessarily exclusively, paper bags to which the present invention is directed and the means of forming and applying paper handles to these bags.

Paper bags can be first manufactured by a bag making machine without handles by cutting blanks of any predetermined size from paper webs followed by folding and bonding the blanks. The bags leave the machine, flat and are usually collected and stored in a hopper for supply to a handle forming and application machine which attaches handles to the outside of preformed bags. This provides bags with external handles.

Alternatively, bags with internal handles can be made (unless produced by hand) by first forming the handles with the bag forming and application machine and then attaching them to the sides of a bag making stock which is subsequently made by the bag making machine into individual bags having handles on the inside faces.

Examples of handle forming and application machines are described in, e.g.: DE 1152 602, U.S. Pat. No. 5,298,007, U.S. Pat. No. 5,609,556, U.S. Pat. No. 2,625,862 and U.S. Pat. No. 2,689,506.

The following is a description of an example handle forming and application machine, known as the Windmöller & Hölscher T1441 Handler, that is well known and in use at the time of the present invention. The Windmöller & Hölscher T1441 Handler is an example of a handle application machine for forming bags with external handles.

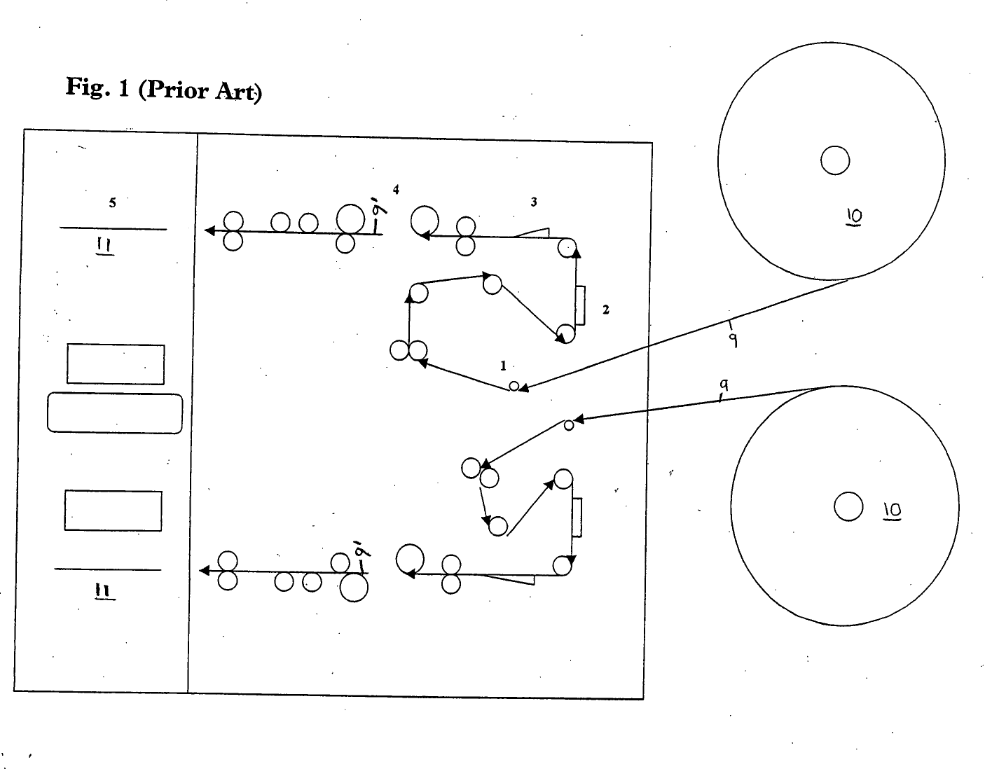

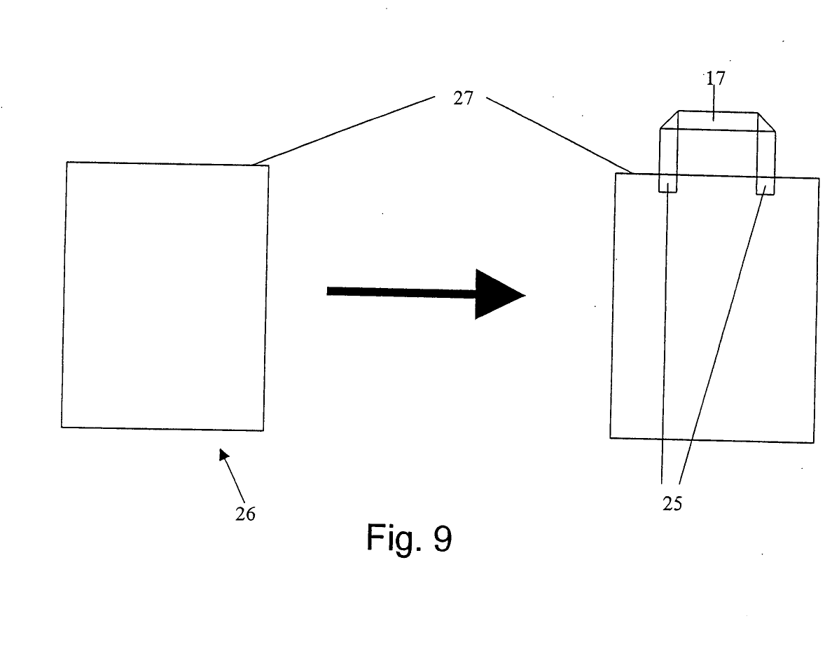

FIG. 1 is a schematic side view of the above named machine. Conventionally, two reels 10 of 45 mm wide paper strip 9 are used to supply the paper stock from which the handles are produced. The paper from each reel 10 is fed to separate, but substantially identical former drums 11, which form the handles and apply them to preformed bags 26 (see FIG. 9) such that two handles are produced simultaneously for attachment to opposite sides of the preformed bags 26.

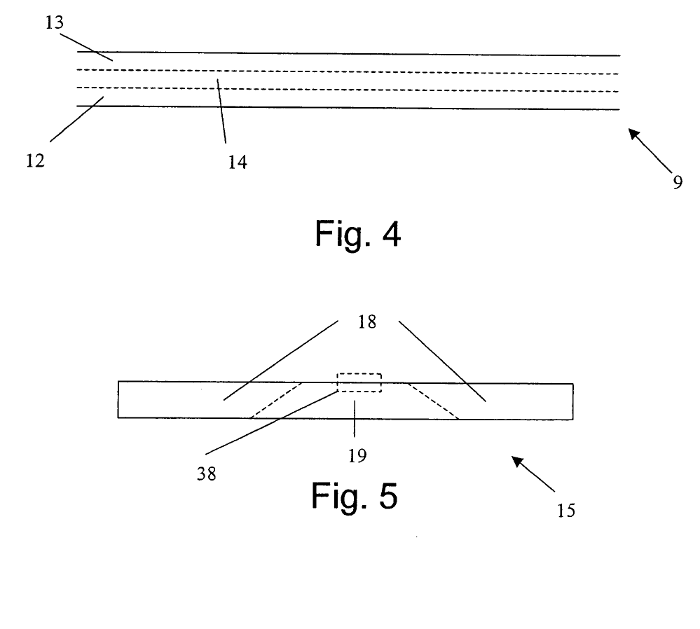

A paper strip 9 from one of the reels is fed first to a paper strip creaser 1, which imparts two parallel longitudinal creases along the length of the paper strip 9, as shown in FIG. 4. The two creases, shown by the dashed lines, divide the strip of paper into three sections, two outer portions 12, 13 and a central portion 14. Glue is coated onto the two outer portions 12, 13 of the creased paper strip 9 by a glue applicator 2 before they are folded inwardly towards the centre portion 14 by a paper strip folder 3. A freshly creased, folded and glued paper strip 9′ is then rolled to ensure flatness, resulting in a three ply paper strip 9′ that is 18 mm in width and has a basis weight of e.g. 375 grams per square metre (gsm).

The layered strip of paper 9′, once cured, is then cut, across its width, and separated by an elliptical gear 4 into smaller individual handle lengths 15 (see FIG. 5). The separated handle lengths 15 are transferred to a rotating former drum 11 which is rotating in a plane perpendicular to the direction of movement of the incoming paper strip 9′.

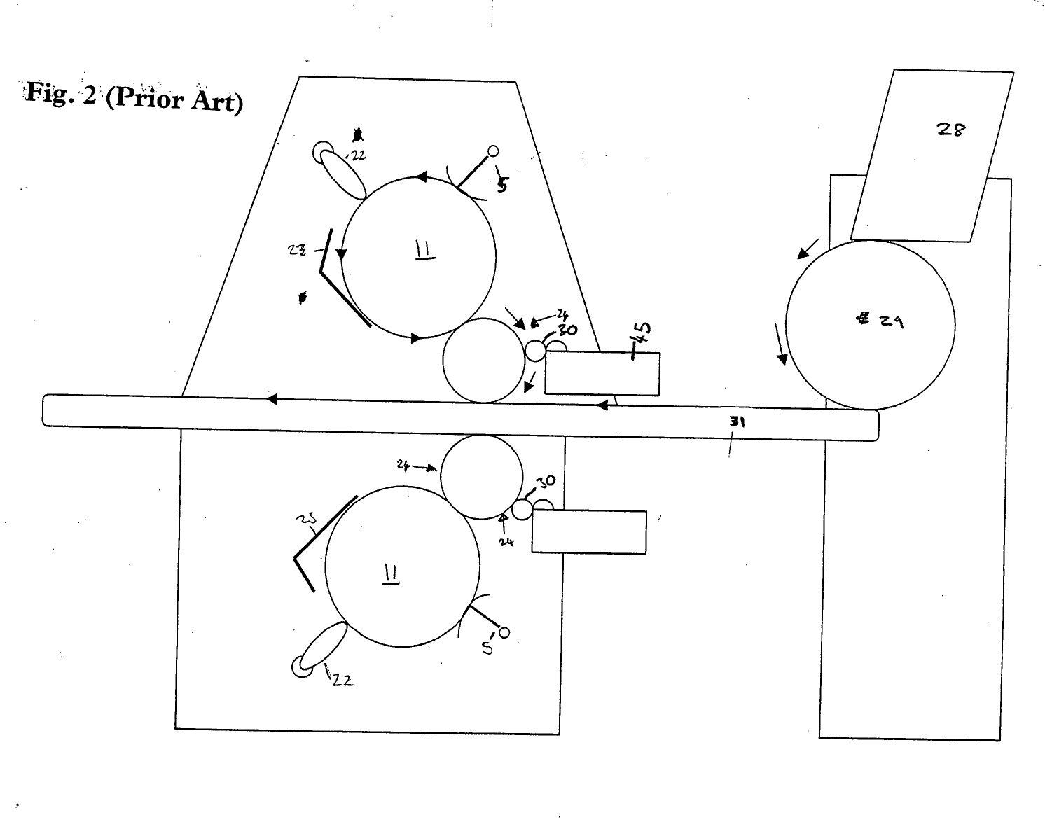

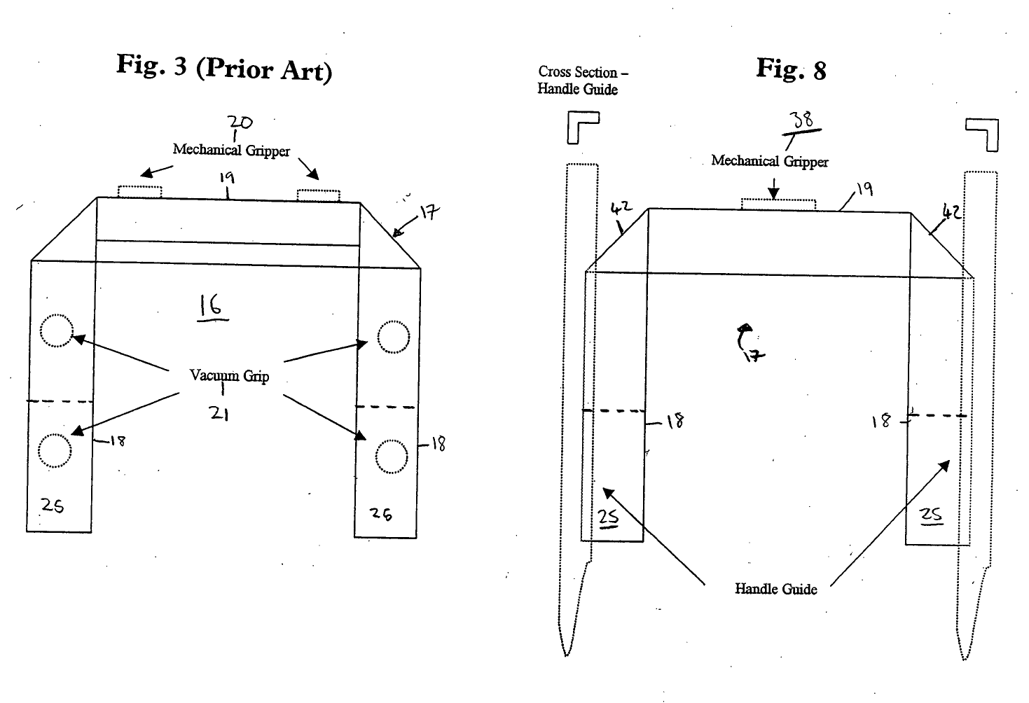

FIG. 2 shows a front view of this machine. A mechanical transfer gripper 5 individually transfers the handle lengths 15 to a vacuum mechanical gripper 16 (see FIG. 3) for gripping the handle lengths 15 to the former drum 11 and across its width. The former drum 11 does not actually look like a drum and is simply a double gripper 16 station running the diameter of the rotating part and rotating at the middle.

The handles 17 formed are of general U-shape with the legs of the U 18 being attached to the preformed bag and the bight of the U 19 for holding the bag when in use. The vacuum mechanical gripper 16 of the prior art is effectively a station either side of the former drum 11 and consists of two parts: the mechanical gripper part 20 and the vacuum gripper part 21. The mechanical gripper part 20 holds each handle length 15 to the former drum 11 at two places, as shown, both of which are inside the bight portion 19 of the substantially U-shaped handle. The vacuum gripper part 21 maintains the legs 18 of the handle 17 in position once they have been folded over as described below.

Referring to FIG. 2, to form the U shape from the incoming handle lengths 15, the handle lengths 15 are creased, by a creaser 22, outside of the mechanical gripper 20 holding them to the former drum. FIG. 5 shows that the creases, again shown by dotted lines, are equally spaced either side of the centre of the handle length 15 with the distance between the creases being determined by the desired dimensions of the handle 17.

Referring back to FIG. 2, the creased handle lengths 15 are then shaped against a forming plate 23 by folding over the parts 18 (see FIG. 5) of the handle lengths 15 outside the creases 18, which will form the legs 18 of the substantially U-shaped handles 17.

The handle length 15, having been dragged through a creaser 22 and the handle shaping former plate 23, is now of substantially U-shaped form. The mechanical gripper part 20 of the vacuum mechanical gripper 16 continues to grasp the bight of the U 19, while the legs of the U 18 are maintained in their now folded over position by the vacuum gripper part 21, which pulls the legs 18 of the U-shaped handle 17 towards the former drum 11.

The U-shaped handle 17 is transferred onto a paste application drum 24, which utilizes the same type of vacuum mechanical gripper 16 as the former drum 11. The paste application drum 24 applies cold adhesive, such as glue, to the peripheral attachment portions 25 (see FIG. 3) of the handle legs 18 that will form the attachment bond with the preformed paper bags. The glue is fed from paste pots 45 to the paste application drum 24 via rollers. As the paste application drum 24 rotates, the gripped handle 17 is pulled through a paste applicator 30 and is brought into contact with the outside of the top edge 27 of a preformed bag 26, thereby attaching the handle 17 to the preformed bag 26, as shown in FIG. 9. A bond is formed joining the attachment portions 25 of the legs of the handle to the preformed bag 26, with the handle 17 extending away from the top edge 27 of the preformed bag 26. The attachment portions 25 can overlap the preformed bag 26 by 75 mm. The actual size of the attachment portions 25 is not critical and is dependent upon the requirements of the final desired dimensions of the preformed bag 26.

Simultaneously, paper from the other reel 29 is processed in the same way along a parallel path comprising an identical former drum 11 and paste application drum 24. Thus, at the attachment stage a substantially U-shaped handle 17 is being applied simultaneously to the opposite outside face of the preformed bag 26.

Referring back to FIG. 2, typically, the preformed bags 26, which are fed from a hopper 28, are fed onto the paste application drum 24 such that the handles 17 and the preformed bags 26 are coincident. In the machine described, the preformed bags 26 fed from the hopper 28 fall onto a mechanical gripper drum 29, which grips a preformed bag 26 from the hopper 28 and rotates towards a chain driven pusher where the preformed bags 26 are deposited. The preformed bags 26 are then pushed towards the paste application drum 24 by belt-driven conveyors 31. The machine of the prior art uses side walls on the conveyors 31 to guide the preformed bags as they are transported towards the area of the machine where the handles 17 are applied.

The preformed bags 26 are conveyed between a nip formed by upper and lower paste application drums 30, where U-shaped handles 17 are bonded to opposite outside faces of the preformed bag 26 by the above described processes.

The preformed bags 26 with handles 17, can then be transferred out of the machine into a collection tray.

The above described Prior Art paper bag handle forming and application machine suffers from many drawbacks, some of which the present invention aims to resolve.

One difficulty encountered in running handle attaching machines of the prior art is that the speed of the former drum and paste application drum are limited by the efficiency of the vacuum of the vacuum mechanical grippers. The speed may also suffer as a consequence of the multiple handle transfers. The machines of the prior art are rated at 150 bags per minute, with the normal operating figure being just 120 bags per minute. However, the prior art bag making machine is capable of supplying bags at 200 to 300 bags per minute meaning that the paper bag handle attaching machine is not running at its full potential. Hence, for optimum machine operation, the handle forming and application machine could be run at a faster speed, closer to the maximum speed of the bag feeder or the bag making stock feeder. The vacuum has a further drawback of having a large energy consumption.

The present invention provides an apparatus for attaching paper handles to bags or bag making material, comprising: a paper source for supplying paper; a first transverse cutting means for cutting the paper across its width into paper segments; a first handle forming and attachment unit for forming the paper segments from the first transverse cutting means into substantially U-shaped handles and attaching the substantially U-shaped handles to a first surface of bags or bag making material; paper segment gripping means for holding a paper segment to the handle forming and attachment unit; and a mechanical guide means extending over at least a portion of the first handle forming and attachment unit for maintaining the substantial U-shape of the handles.

A corresponding method for manufacturing paper handles is also provided.

The method and apparatus of this aspect of the invention provides a means of gripping the handle segments to the handle forming and attachment unit without the use of vacuum.

This will allow the machine to operate at speeds not limited by the efficiency of any vacuum and improve the energy efficiency of the machine.

In prior art handles, each handle is transferred four times: to the transfer gripper; to the vacuum mechanical gripper at the former drum; to the paste application drum and finally to the preformed bag. Each transfer increases the risk and incidence of a transfer failure, which will reduce the handle application efficiency of the machine and would result in paper jams which take time to fix.

In a preferred embodiment, the invention provides an apparatus for attaching paper handles to bags or bag making material, wherein feeding means for feeding the paper segments to the handle forming and attachment unit impart sufficient momentum to the paper segment to transfer the paper segment to the first handle forming and attachment unit by means of the momentum imparted to it. Also in a preferred embodiment, the paper segment is held by the gripping means in use during forming into a substantially U-shaped handle and wherein said gripping means releases the handle for attachment to the bag or bag making material.

This preferred embodiment of the invention reduces the number of transfers in transferring the paper to the handle forming and attachment unit and during the handle forming and attachment process as compared to the Prior Art. Less transfers means a lower risk of transfer failure.

The ply of the paper is therefore maintained from paper supply to the handle forming and attachment units.

A paper strip having a basis weight of 375 grams per square metre (gsm), as is conventionally used for making handles in the machine described above, is far greater than what is usually needed to hold the bag for normal applications. The paper layering or folding (as described above in relation to FIG. 4) is standard in prior art machines, but introduces additional steps and complications to the paper bag handle forming process and apparatus. Furthermore, the creaser, needed to allow folding of the single-ply strip into a three-ply strip, turns a full revolution for each handle, the impact doing sufficient damage to the paper to require a minimum paper thickness of no less than 330 gsm. This increased wear of the handles due to effects of the extreme creasing operation has resulted in the use of heavier paper than would normally be needed for a bag handle in use. Also, the paste pots which provide the glue used to fix the paper strip into its layered configuration, needs to be constantly topped up for proper function, thus adding expense to the handle forming operation.

Another preferred embodiment of the invention provides an apparatus for attaching paper handles to bags or bag making material, wherein the paper from the paper source is greater than 250 gsm.

The paper for making the handles is not creased and folded in the longitudinal direction and glued in place to form thicker paper. A lower basis weight paper can, therefore, be used, which is more suitable for its eventual use and more cost effective. Glue is obviously no longer needed to hold the folds of the layered strip of paper into position, so production costs are reduced.

The use of two reels of paper strip in the Prior Art, as the starting stock for forming the handles, requires two reel changes when the need arises. This can prove both time consuming and troublesome.

According to a further preferred embodiment, there is provided an apparatus for attaching paper handles to bags or bag making material, including a longitudinal cutting means for cutting the paper along its length into a plurality of paper strips; a second transverse cutting means for cutting a paper strip across its width into paper segments; and a second handle forming and attachment unit for forming paper segments from the second transverse cutting means into a substantially U-shaped handle and attaching the substantially U-shaped handle to a second surface of the bag or bag making material; and feeding means for feeding the paper strips from the longitudinal cutting means either to the first transverse cutting means or to the second transverse cutting means.

This embodiment of the invention provides a machine with only a single source of paper, meaning less paper is required to produce a pair of handles than in the Prior Art and less time is required for the changeover of the paper source.

In the prior art, the gripper drum, when removing bags from the hopper, sometimes has a tendency to take more than one bag at a time. Any extra bags will serve to jam up the former drum. Also, an operator is required on either end of the machine, feeding the bags in and taking them off, with the operator feeding the bags also monitoring for double bag feed. When bags jam in the handle forming and application machine, they usually knock out the timing of the conveyor belts feeding the bags to the former drums. Also, every time a bag jams in the machine it may knock out the alignment of some or all of the parts of the former drum such as the creaser, the shaping of the handles against the former plate, or even the vacuum mechanical grippers. These bag jams can take an excessive time to fix. The problem of multiple simultaneous bag feed not only involves the extra labour costs of having the bag feeder monitored, but also involves machine downtime and the need for maintenance when a jam occurs. Furthermore, when the size of the preformed bags are changed, the grippers and the conveyor side walls require changing. Hence, both the hopper and the conveyors need adjusting to fit the bag being used.

Another preferred embodiment of the invention provides an apparatus for attaching paper handles to bags or bag making material, including a transport means for feeding bags or bag making material from a bag or bag making material supply unit, said supply unit for supplying bags or bag making material to the first handle forming and attachment unit, wherein the apparatus further comprises a bag gripping means for removing the bags or bag making material from the bag supply unit and an air under pressure supply for pushing the bags or bag making material to the transport meansthe bags are pushed from the bag supply unit to the transport means using air under pressure.

This preferred embodiment of the invention can be used in combination with a handle application machine of the prior art, but is preferably used with the apparatus provided by the present invention.

This embodiment provides a more reliable bag supply, with the incidence of multiple simultaneous bag feed being reduced compared to that of the Prior Art.

Maintenance of the handle application machines of the Prior Art can take up to two hours because of the present structure of the machines. The frequency of breakdowns due to multiple simultaneous bag feeds and the length of each maintenance time reduce the productive output of the machine.

Another preferred embodiment of the invention provides an apparatus for attaching paper handles to bags or bag making material, including side access means for accessing the internal components of the apparatus from at least one side of the machine.

This embodiment of the invention provides a side access means, which should considerably reduce maintenance time, especially when fixing bag jams.

In a preferred embodiment of the invention, a method and apparatus is provided wherein the paper is cut along its width into paper segments which are transferred to the handle forming and attachment unit and decelerated and appropriately positioned to allow gripping by the gripping means, with this decelerating and positioning preferably occurring by means of a brush.

Another preferred method and apparatus of the invention provides cutting means for cutting the paper along its width into paper segments and a gripping means for gripping the paper segments to the handle forming and attachment unit during handle forming, application of handle attaching means to the substantially U-shaped handle and releasing of the paper segment by the gripping means for attachment to a bag or bag making material of the substantially U-shaped handle.

In a further preferred method and apparatus of the invention there is provided a bag supply unit for the supply of bags and a transport means for feeding the bags from the bag supply unit to the handle forming and attachment unit, wherein the bag supply unit comprises a bag container and a bag gripping means and wherein a bag is removed from the bag container in a direction not in the direction of movement of the transport means and wherein air under pressure pushes the removed bag to the transport means. Preferably, the bag passes through a brush during transferring from the bag supply unit to the transport means.

In another preferred method and apparatus of the invention there is provided a removable bag supply unit.

The present invention provides a handle forming and application machine which solves the above mentioned problems.

Preferred embodiments of the invention will now be described by way of example only and with reference to the drawings.

FIG. 1 shows a side view of a prior art handle forming and application machine, as previously described.

FIG. 2 shows a front view of the machine of FIG. 1.

FIG. 3 shows a vacuum mechanical gripper holding a handle against a former drum of the prior art, as described above.

FIG. 4 shows a paper strip after being creased along the length of the paper by the machine of the Prior Art.

FIG. 5 shows an individual handle length with creases for allowing it to be folded into a U shaped handle.

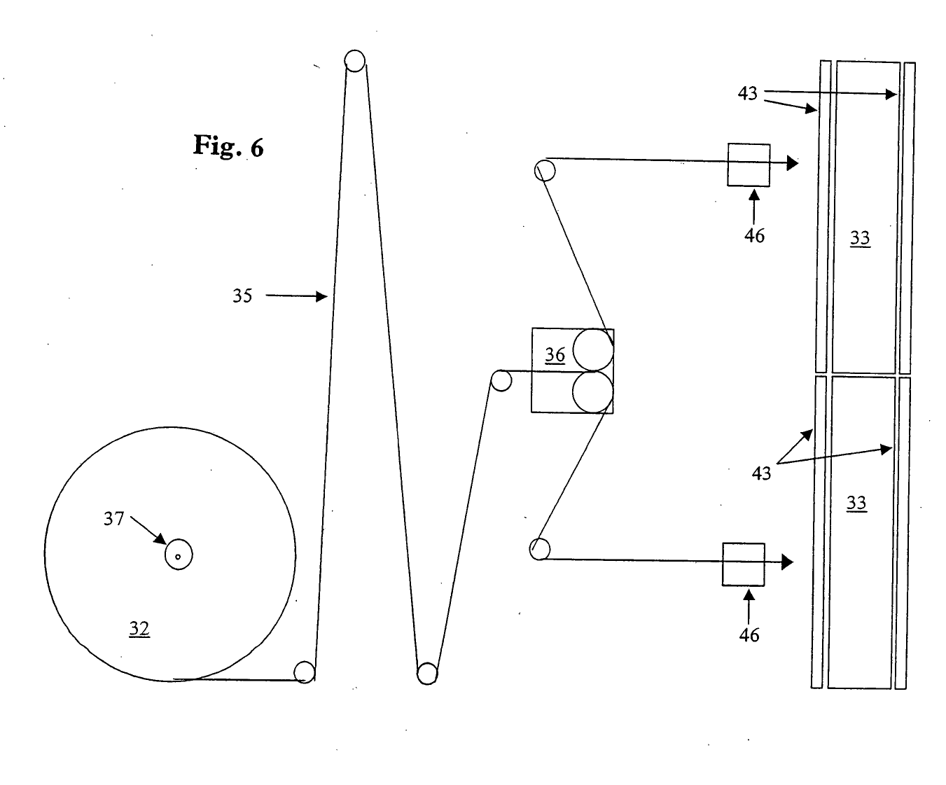

FIG. 6 shows a side view of the paper handle forming and application machine of the present invention.

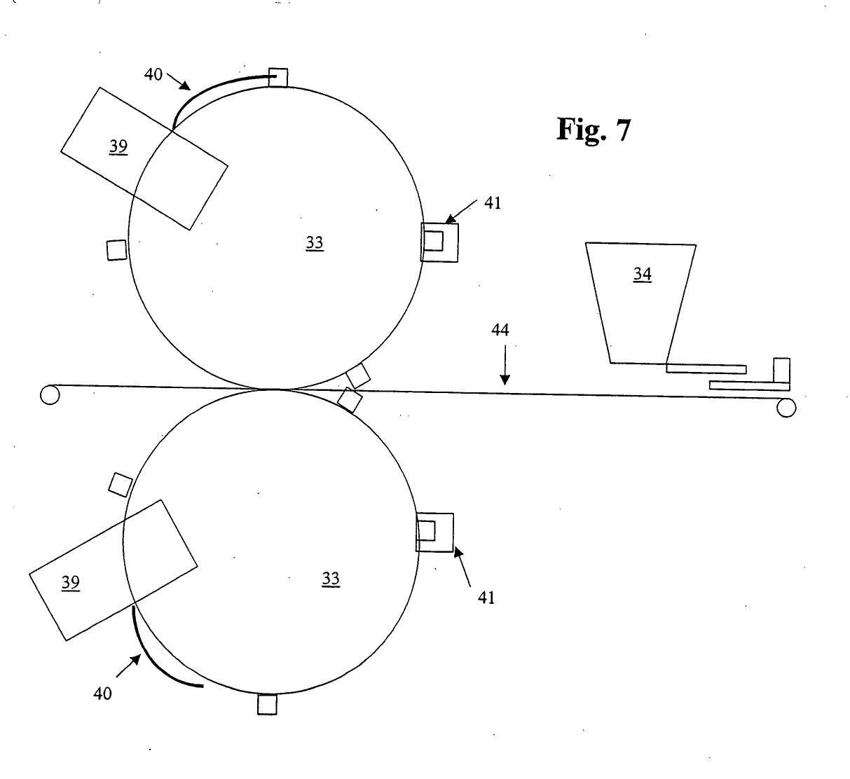

FIG. 7 shows a front view of the machine of FIG. 6.

FIG. 8 shows a mechanical gripper and raised rail guide holding a handle against the former drum according to the present invention.

FIG. 9 shows a preformed paper bag before and after handle application.

As shown in FIGS. 6 and 7, the handle forming and application machine of the present invention consists of three major components: a single paper source 32, two parallel former drums 33 (which, in parallel, provide handles 17 for each side of the preformed bags 26) and a bag supply 34. The paper source 32 is a reel of paper strip 35. The paper strip 35 is cut down the middle into two halves, one half being fed to each of the former drums 33, as a starting stock for forming the handles 17. The paper strip 35 is cut into appropriately sized handle lengths 15 before being accepted by the former drum 33. The former drum 33 creases and folds the handle lengths 15 into individual substantially U-shaped handles 17. This handle making process is carried out essentially simultaneously on each former drum 33 so as to provide pairs of handles for application to the outside of opposite sides of preformed bags 26 being fed to the former drum 33. The bag supply 34 controls the feeding of one preformed bag 26 at a time, without handles, to the former drum 33.

An alternative to the above described machine is to use bag making stock instead of preformed bags 26. The handles 17 will be manufactured first, in accordance with the methods and apparatus of the present invention, and attached to the bag making material. The bag manufacturing machine will then form the bag making material into individual bags. The present invention can, therefore, produce bags with internal or external handles 17.

In a preferred embodiment of the present invention, the source of the paper strip 35 is a single reel 32 of 38 mm wide paper held on a turret stand 37. The turret stand 37 will allow quick changeover when the need occurs. The paper is pulled from the reel 32 and fed, by conventional means such as rollers, to a cutter 36 for dividing the paper strip 35 roughly down the middle in a longitudinal direction. This provides a paper strip 35 for each former drum 33, while only a single reel source 32 is used. Each paper strip 35 is then fed to a respective former drum 33 for handle forming and application to different sides of the preformed paper bags 26 or bag making stock.

The paper strips 35 are provided to the former drums 33 without any creasing, folding or layering and without gluing the outer portions 12, 13, (see FIG. 4) as required in the Prior Art machines described above. Conventionally, the ply of the paper is increased by the creasing and folding steps, but this is preferably not performed by the process of the present invention where the ply of the paper strip 35 is maintained from the reel 32 to the former drum 33.

The layering of the paper is not required because the handle lengths 15 are not treated as roughly in the later stages of the handle forming and application process of the invention as they are in the prior art. This overall reduction in processing steps and wear of the paper means a lower basis weight paper of preferably between about 250 to about 280 gsm may be provided at the former drum 33. However, the exact basis weights used can obviously be altered to the specific requirements of the handle 17 ultimately produced. The paper strip 35 can be thinner in width than is conventional, as although it is being cut into two paper strips 35, it is not being folded into three layers, as in the Prior Art. In its preferred forms, the present invention, therefore, uses less paper than is conventional.

One example of the dimensions of the paper strip 35 used is 38 mm in width at its source, before being cut into two paper strips 35 of 19 mm in width each. Again, any specific width paper strip 35 may be used to suit the needs of the handles 17 eventually produced.

The paper strip 35 requires fewer processing steps before being fed to the former drum 33 compared to the prior art, requiring a less complicated processing apparatus. Furthermore, there is no need for a constant supply of glue to the paper strip 35. Another advantage is that the paper strip 35 provided to the former drum 33 has not been damaged by any creasing step and as it is, in its preferred form, only single-ply, it will be more easily manipulated when folding into substantially U-shaped handles 17.

The paper strip 35 is, as is conventional, cut across its width and separated into separate handle lengths 15 (shown in FIG. 5) appropriately sized as required for the eventual handle 17, before being fed to the former drum 33. Any means known in the art can be used to cut and separate these handle sections or lengths from the paper strip 35.

The handle lengths 15 are transferred to the surface of the former drum 33. The cylindrically shaped former drum 33 accepts the incoming handle lengths 15 across its width. The former drum 33 is rotating in a plane perpendicular to the direction of movement of the incoming handle lengths 15, such that if viewed in the line of the direction of movement of the incoming handle lengths 15, the handle lengths 15, once positioned on the rotating former drum 33, would be travelling either left or right depending on whether the drum was rotating clockwise or anticlockwise respectively. Each handle length 15, once positioned on the former drum 33 is grasped by a spring-loaded gripper 38 (shown in FIG. 6). The handle lengths 15 are transferred from the former drum 33 and forced onto the spring-loaded gripper 38 only by means of the machine speed. The momentum imparted to the handle length 15 as it is fed to the former drum 33 is, preferably, all that is used in transferring the handle length 15 to the former drum 33. Preferably, no additional transferring means are used to perform the handle length 15 transfer. A brush, acting as a brake, is used to decelerate the handle lengths 15 and properly position them on the former drum 33.

As shown in FIG. 5, the spring-loaded gripper 38 catches the leading edge of the handle length 15, relative to the rotation direction of the former drum 33. The handle length 15 is grasped, preferably, in a single centrally located position by the spring-loaded gripper 38.

With reference to FIG. 7, the handle length 15 continues to be held to the former drum 33 by the spring loaded gripper 38 as it is passed through a cylindrical creaser 39, a former plate 40 and a hot melt applicator 41. The cylindrical creaser 39 serves to crease the handle section 15 across its width, generally, in two positions, as shown by the dotted lines in FIG. 5, equally spaced from the centre 19 of the handle length. As shown in FIG. 8, these creases are where the corners 42 of the portion of the produced handle 17 to be held by the user will occur. As can be seen, the distance between these creases form the portion of the handle 17 to be held. Referring now to FIG. 5, the two portions 18 outside of these creases are folded over at the former plate 40, preferably backwards relative to the rotation direction the former drum 33, so away from the leading edge being gripped by the spring loaded gripper 38, to form the legs 18 of the handle 17 as shown in FIG. 8.

This results in a substantially U-shaped handle 17, with the parallel legs 18 of the U being the result of the fold over of the two outside parts 18 of the creased handle length 15. The bight of the U 19 achieved from this process is the portion of the handle 17 to be held when in use.

Any creasing and folding means known in the art to produce such handles 17 may be used. Furthermore, the exact shape of the handles 17 is not essential as long as it performs the purpose of providing a handle 17 to be held when carrying a bag 26.

The hot melt applicator 41 applies hot melt adhesive to the attachment portions 25 of the legs 18 of the U-shaped handles 17, as shown in FIG. 8. FIG. 9 shows how the attachment portions 25 serve to overlap with the outside of the top edge 27 of the sides of the preformed bags 26 so that the handles 17 are fixed to the preformed bags 26 thereby producing bags with external handles. Alternatively, the handles 17 are attached in the same way only to bag making stock before it is made into individual bags with internal handles 17. The handles 17 are not transferred to a separate pasting drum as is conventional in the art for applying cold adhesive to the legs 18 of the handles 17. Instead, the spring loaded gripper 38 continues to hold the U-shaped handle 17 as the hot melt adhesive is coated onto the attachment portions 25 of the legs 18 of the U-shaped handles 17. Any other means for attaching the U-shaped handles 17 to the preformed bags 26 can, of course, be used.

The spring loaded gripper 38 is finally forced to release the handle 17 by a cam at the centre of the former drum when the handle is to be applied to the preformed bags 26 or the bag making stock.

Thus, in the preferred embodiment, there are only two transfers of each handle 17: to the spring-loaded gripper 28 and to the preformed bags 26 or the bag making stock. This is an improvement over the prior art where four transfers are generally employed. This improvement reduces the risk of transfer failures.

Preferably, a raised rail guide 43 extends around a portion, or all, of the former drum 33 to maintain the U-shape of the handles 17 once the legs 18 have been folded into position. As the U-shaped handles 17 rotate on the former drum 33 for hot melt application and attachment, the foldover portions 18 of the handles 17 are maintained in this state by means of the raised guide rail 43 and without the need for vacuum suction pulling the legs 18 toward the drum. This, in combination with the spring-loaded gripper 38, eliminates the need for any vacuum in the machine, as is desirable. The machine speed is therefore not limited by the efficiency of any vacuum. This along with other improvements in the operation of the handle forming and application machine, as describe above, makes the machine capable of running at a speed comparable to the rate of the bag manufacturing machine, e.g. 280 bags per minute, and is preferably geared to operate at that speed. The lack of vacuum should also reduce the energy consumption of this part of the machine, as compared to the prior art.

Although the present description describes an embodiment in which two handles are made at a time, it is possible that the invention could be incorporated into a machine which manufactures more than two handles in parallel. In such a machine, for example, more than two parallel paths of drums could be provided. Alternatively, a number of equally spaced spring loaded grippers 38 may be disposed over the circumference of the former drum 33 so that a plurality of preformed bags 26 can be processed during any one revolution of the former drum 33. Preferably, as is shown in FIG. 7, there are four spring loaded grippers 38 spaced around the circumference of the former drum 33 such that four bags have handles 17 applied per revolution of the former drum 33. The spring loaded grippers could be spaced along the width of the circumference of the former drum 33 or spaced length ways as shown. The former version will require parallel preformed bag or bag making stock feeds 26 and the paper strip 35 being longitudinally cut by cutter 36 into an appropriate number of paper strips 35. The latter version will require preformed bags 26 or bag making stock to be fed at the same frequency as the handles 17 are being produced. These alternatives will require slightly different configurations of the machine, such as to the paper strip feeding means, the cutter 36, possibly, though not preferably, the number of reels, the preformed bag 26 feeding rate and style, etc. Such modifications would be appreciated by one skilled in the art.

With reference to FIG. 7, preformed bags 26 may be collected and stored in a hopper 34 for use as the supply of preformed bags 26 for application of handles 17 by the above described machine, as is well known in the art. Alternatively, the supply of the preformed bags 26 may be a conveyor feeding bags directly from a bag manufacturing machine. Preferably, the hopper 34 is removable, thereby allowing for both configurations. Preferably, upon removal of the hopper 34, the motor for the paper bag carrying conveyor would be disconnected and the machine would be linked directly to the bag manufacturing machine.

In the case where no hopper is used and the bag making machine and the handle attaching machine are linked, either preformed bags are fed to the handle attaching machine or paper bag making stock is fed. Either way, the handle attaching machine is, preferably, run at the same speed as the top speed, or near the top speed, of the bag manufacturing machine, e. g. 200 to 300 bags per minute. When bag making stock is fed to the handle attaching machine, the basic design of the handle attaching machine will be the same as in the handle attaching machine being fed with preformed bags 26. One minor adjustment that would need to be made is in the mechanism for transferring the handles 17 to the bag making stock. This can be any standard transfer unit for attaching handles 17 to bag making stock, preferably, in combination with the handle attaching apparatus already disclosed.

In the case where a hopper 34 is used, the preformed bags 26 are pulled down and backwards out of the hopper 34 by a gripper, relative to the direction of movement of the conveyor delivering the preformed paper bags 26 to the former drum 33. A jet of air pushes a single preformed bag 26 forwards onto a pusher 44 on the chain feed. The preformed bags 26 are generally deployed onto the pusher 44 on the chain feed with the base of the preformed bag 26 leading. Another brush is used either to ensure that the gripper only removes one preformed bag 26 at a time from the hopper 34 or the jet of air only forces one preformed bag 26 onto the pusher 44 at a time. By pulling the preformed bags 26 out of the hopper 34 backwards, multiple simultaneous bag feed would not necessarily result in more than one preformed bag being fed onto the chain pusher 44, as this is done in a separate step by the jet of air. These features, in combination with the use of a brush to ensure only a single preformed bag 26 feed, reduce the risk of multiple simultaneous bag feed as compared to the bag supply conventionally used to supply preformed bags 26 from a hopper 34.

This design of bag supply allows the size of the paper bags to be changed without altering the conveyor walls as the preformed bag 26 is just being pushed along the conveyor. The removability of the hopper 34 has the further advantage that when bag size is changed, the hopper 34 is simply replaced. Thus, bag size changes can be implemented more quickly and more easily as compared with the prior art.

Fewer occurrences of multiple simultaneous paper bag feed will reduce the incidence of machine jam, especially at the former drums 33. This will reduce the costs incurred during machine downtime as compared to the prior art machines.

Preformed bags 26 or bag making stock are fed from the bag supply to the nip between the two former drums 33 where handles 17 are applied to either side of the preformed bag 26. The preformed bags or bag making stock are carried to the former drums 26 by conventional transport means, such as belt-driven conveyors. In a preferred embodiment of the invention, the side of the machine may be removable or openable, and is preferably hinged to allow access to the internal components of the machine, such as the preformed bag or bag making stock feeding conveyors, the former drum 33 and the hopper 34. This way, should a chain link of the chain drive of the preformed bag or bag making stock feeding conveyor break, or a jam of any other parts of the handle forming and application machine, such as the former drum 33 or the hopper 34, occur, the source of the problem can be easily identified and accessed by maintenance crews. It is estimated that breakdown should take only 15 minutes to fix and less than 5 minutes for most breakdowns. Thus, not only is the frequency of machine breakdowns reduced by the present invention, so is the maintenance time required for such breakdowns.

The bags, with handles applied, are then collected in the usual manner.

The present disclosure provides numerous new features and advantages over conventional paper bag handle forming and application machines and methods of applying handles, as will be readily apparent to one skilled in the art upon reading the description and the claims.

1. An apparatus for attaching paper handles to bags or bag making material, comprising: a paper source for supplying paper; a first transverse cutting means for cutting the paper across its width into paper segments; a first handle forming and attachment unit for forming the paper segments from the first transverse cutting means into substantially U-shaped handles and attaching the substantially U-shaped handles to a first surface of bags or bag making material; a paper segment gripping means for holding a paper segment to the handle forming and attachment unit; and a mechanical guide means extending over at least a portion of the first handle forming and attachment unit for maintaining the substantial U-shape of the handles.

2. The apparatus for attaching paper handles to bags or bag making material according to claim 1, further comprising: a longitudinal cutting means for cutting the paper along its length into a plurality of paper strips; a second transverse cutting means for cutting a paper strip across its width into paper segments; a second handle forming and attachment unit for forming the paper segments from the second transverse cutting means into substantially U-shaped handles and attaching the substantially U-shaped handles to a second surface of the bags or bag making material; and paper strip feeding means for feeding the paper strips from the longitudinal cutting means either to the first transverse cutting means or to the second transverse cutting means.

3. The apparatus according to claim 1 wherein the paper source is a single reel on a turret stand.

4. The apparatus according to claims 1 wherein the paper source supplies paper which is less than 45 mm wide.

5. The apparatus according to claims 4 wherein the paper from the paper source is 38 mm wide.

6. The apparatus according to claims 1 wherein the apparatus is configured to supply paper to the first transverse cutting means which is 19 mm wide.

7. The apparatus for attaching paper handles to bags or bag making material of claim 1, further comprising: paper segment feeding means for feeding the paper segments to the first handle forming and attachment unit; wherein the feeding means are adapted to impart sufficient momentum to the paper segments to transfer the paper segments to the first handle forming and attachment unit.

8. The apparatus according to claim 7 further comprising a brush for decelerating the paper segments and positioning the paper segments on the first handle forming and attachment unit.

9. The apparatus according to claim 1, wherein the first handle forming and attachment unit comprises a creasing means and a folding means.

10. The apparatus according to claim 1 wherein the paper segment gripping means is configured to continue to hold the paper segment during forming the paper segment into a substantially U-shaped handle and application of handle attachment means to the substantially U-shaped handle and to release the handle for attachment to the bags or bag making material.

11. The apparatus according to claim 1, further comprising an attachment means application unit which is configured for applying the attachment means to the substantially U-shaped handles while the substantially U-shaped handles are held by respective paper segment gripping means to the first handle forming and application unit, said application unit stationed at the first handle forming and attachment unit.

12. The apparatus according to claim 1 wherein the apparatus is configured to maintain the ply of the paper from the paper source to the first handle forming and attachment unit.

13. The apparatus according to claim 12 wherein the apparatus is configured to supply the paper from the paper source to the first handle forming and attachment unit without folding the paper or creasing the paper in the longitudinal direction.

14. The apparatus according to claim 1 wherein the apparatus is configured to supply single ply paper to the first handle forming and attachment unit.

15. The apparatus for attaching paper handles to bags or bag making material according to claim 1, wherein said apparatus is configured to use the paper from the paper source having a basis weight of greater than 250 grams per square meter.

16. The apparatus according to claim 15 wherein the apparatus is configured to supply paper to the first handle forming and attachment unit having a basis weight of less than 375 grams per square meter.

17. The apparatus according to claim 16 wherein the paper supplied to the first handle forming and attachment unit has a basis weight of less than 330 grams per square meter.

18. The apparatus according to claim 17 wherein the paper supplied to the first handle forming and attachment unit is between 250 and 280 grams per square meter.

19. The apparatus according to claim 1 wherein the mechanical guide means comprises a raised rail guide extending around at least a portion of the first handle forming and attachment unit for maintaining the legs of the substantially U-shaped handles in a folded position.

20. The apparatus according to claim 1 wherein the apparatus is configured to attach greater than 150 pairs of handles per minute.

21. The apparatus according to claim 20 wherein the apparatus is configured to attach 280 pairs of handles per minute.

22. The apparatus of claim 1 for attaching paper handles to bags or bag making material, further comprising: a transport means for feeding the bags or bag making material from a bag or bag making material supply unit to the first handle forming and attachment unit, said supply unit supplying bags or bag making material for handle attachment, wherein the apparatus further comprises a bag gripping means for removing the bags or bag making material from the bag supply unit and a supply of air under pressure for pushing the bags or bag making material to the transport means.

23. The apparatus according to claim 22 wherein the bag gripping means is arranged to remove the bags or bag making material from the bag or bag making material supply unit in a direction not in the direction of movement in use of the transport means.

24. The apparatus according to claims 22 further comprising a brush for sweeping the bag or bag making material removed from the bag or bag making material supply unit.

25. The apparatus for attaching paper handles to bags or bag making material according to claim 22, wherein the bag or bag making material supply unit is removable and is replaceable with a continuous bag or bag making material feed.

26. The apparatus according to claim 25 wherein the transport means is adapted to receive bags or bag making material of different forms.

27. The apparatus according to claim 25 wherein the removable bag or bag making material supply unit is replaceable with another removable bag or bag making material supply unit.

28. The apparatus according to claim 27 wherein the other removable bag or bag making material supply unit is for supplying bags or bag making material of different form to the bags or bag making material supplied by the replaced removable bag or bag making material supply unit.

29. The apparatus according to claims 26 wherein bags or bag material of different forms includes bags or bag making material of different sizes.

30. The apparatus for attaching paper handles to bags or bag making material according to claim 1, further comprising side access means for accessing the internal components of the apparatus from at least one side of the apparatus.

31. The apparatus according to claim 30 wherein the side access means comprises the at least one side of the apparatus being hinged to allow opening of the entire at least one side.

32. A method for attaching paper handles to bags or bag making material, comprising the steps of:
supplying paper from a paper source;
cutting the paper across its width into paper segments with a first transverse cutting means;
forming the paper segments from the first transverse cutting means into substantially U-shaped handles and attaching the substantially U-shaped handles to a first surface of bags or bag making material with a first handle forming and attachment unit; and
holding the paper segments to the handle forming and attachment unit with paper segment gripping means; wherein said substantially U-shaped handle is held to the handle forming and application unit by the paper segment gripping means while a mechanical guide means maintains the substantial U-shape of the handle.

33. The method of claim 32, further including
cutting the paper along its length into a plurality of paper strips with a longitudinal cutting means;
feeding the paper strips either to the first transverse cutting means or to a second transverse cutting means;
cutting a paper strip fed to the second transverse cutting means across its width into paper segments;
forming the paper segments from the second transverse cutting means into substantially U-shaped handles and attaching the substantially U-shaped handles to a second surface of the bags or bag making material with a second handle forming and attachment unit.

34. The method of claim 32 wherein the paper source is a single reel on a turret stand.

35. The method of claims 32, further comprising supplying paper from the paper source which is less than 45 mm wide.

36. The method of claim 35 wherein the paper from the paper source is 38 mm wide.

37. The method of claims 32, wherein the paper supplied to the first or second transverse cutting means is 19 mm wide.

38. The method of claims 32, further comprising feeding the paper segments to the first handle forming and attachment unit with paper segment feeding means, wherein the step of feeding the paper segments to the first handle forming and attachment unit imparts sufficient momentum to the paper segments to transfer the paper segments to the handle forming and attachment unit.

39. The method of claim 38, comprising decelerating the paper segments and positioning the paper segments on the handle forming and attachment unit with a brush.

40. The method of claims 32, wherein the paper segment gripping means continues to hold the paper segments during forming into a substantially U-shaped handle and application of handle attachment means and releases the handles for attachment to the bags or bag making material.

41. The method of claim 32, further comprising applying handle attachment means to the substantially U-shaped handles with an attachment means application unit while the substantially U-shaped handle is held to the first handle forming and attachment unit by the paper segment gripping means.

42. The method of claim 32, further comprising maintaining the ply of the paper from the paper source to the first handle forming and attachment unit.

43. The method of claim 42, further comprising supplying paper from the paper source to the first handle forming and attachment unit without folding the paper or creasing the paper in the longitudinal direction.

44. The method of claims 32, further comprising supplying single ply paper to the first handle forming and attachment unit.

45. The method of claim 32, further comprising supplying paper from the paper source having a basis weight of greater than 250 grams per square meter.

46. The method of claim 45, wherein the paper supplied to the first handle forming and attachment unit has a basis weight of less than 375 grams per square meter.

47. The method of claim 46, wherein the paper supplied to the first handle forming and attachment unit has a basis weight of less than 330 grams per square meter.

48. The method of claim 47, wherein the paper supplied to the first handle forming and attachment unit is between 250 and 280 grams per square meter.

49. The method of claims 32, wherein the mechanical guide comprises a raised rail guide, extending around at least a portion of the first handle forming and attachment unit, which maintains the legs of the substantially U-shaped handles in a folded over position.

50. The method of claims 32, wherein the apparatus attaches greater than 150 pairs of handles per minute.

51. The method of claim 50, wherein the apparatus attaches 280 pairs of handles per minute.

52. The method of claim 32, further comprising the steps of feeding the bags or bag making material from a bag or bag making material supply unit to the first handle forming and attachment unit with a transport means; removing the bags or bag making material from the bag supply unit with bag gripping means; and pushing the bags or bag making material to the transport means using air under pressure.

53. The method of claim 52, wherein the bags or bag making material are removed from the bag supply unit in a direction not in the direction of movement of the transport means.

54. The method of claim 52, further comprising the step of sweeping the bag or bag making material removed from the supply unit with a brush.

55. The method of claim 52, wherein the bag supply unit is removable.

56. The method of claim 55, comprising the steps of removing the bag supply unit and replacing it with a continuous bag or bag making material feed.

57. The method of claim 52, further comprising the step of removing the bag or bag making material supply unit and replacing it with another bag or bag making material supply unit.

58. The method of claim 57 wherein the bags or bag making material supplied from the other bag or bag making material supply unit are of a different form as compared to the bags or bag making material supplied from the replaced removable bag or bag making material supply unit.

59. The method of claim 58, wherein the bags or bag making material of different forms includes bags or bag making material of different sizes.
